(19) United States
(12) Patent Application Publication
(10) Pub. No.: US 2025/0071783 A1
(43) Pub. Date: Feb. 27, 2025

(54) ADVANCE INDICATION OF RESOURCE SELECTION

(71) Applicant: Panasonic Intellectual Property Corporation of America, Torrance, CA (US)

(72) Inventors: Yang KANG, Singapore (SG); Hidetoshi SUZUKI, Kanagawa (JP); Hong Cheng Michael SIM, Singapore (SG); Xuan Tuong TRAN, Singapore (SG); Yoshihiko OGAWA, Kanagawa (JP)

(21) Appl. No.: 18/726,958

(22) PCT Filed: Nov. 11, 2022
(86) PCT No.: PCT/SG2022/050823

§ 371 Date: Jul. 5, 2024

(30) Foreign Application Priority Data
Jan. 6, 2022 (SG) 10202200145R

(51) Int. Cl. H04W 72/25; H04W 52/02; H04W 72/02; H04W 76/28

(52) U.S. Cl. CPC H04W 72/25; H04W 52/0209; H04W 72/02; H04W 76/28

(57) ABSTRACT

Communication apparatuses and methods for advance indication of resource selection in DRX configured sidelink (SL) communications are provided. The techniques disclosed here feature a method for wireless communication at a first user equipment (UE). The method comprises: transmitting an advanced indication to a second UE for an upcoming sidelink communication with the second UE over a sidelink communication link, wherein the upcoming sidelink communication is associated with one or more selected resources that include at least one resource falling outside the second UE's active time in Discontinuous Reception (DRX) configuration.

### BACKGROUND

### 1. Technical Field

The present disclosure relates generally to wireless communications, and more particularly relates to communication methods and communication apparatuses for advance indication of resource selection in DRX configured sidelink (SL) communications.

### 2. Description of the Related Art

Sidelink (SL) communication is a type of communication that allows communication apparatuses to connect directly to one another and communicate without relaying their data via a base station. In a SL communication, a communication apparatus that transmits data to other communication apparatus(es) is referred to as a transmitting (Tx) user equipment (UE). Likewise, a communication apparatus that receives data from other communication apparatus(es) is referred to as a receiving (Rx) UE. It is appreciable to those skilled in the art that a communication apparatus working as a Tx UE in a SL communication can work as a Rx UE in another SL communication.

In SL communications, discontinuous reception (DRX) with Rx UE's active/inactive time was introduced in 3GPP Release 17 (R17) for power saving purpose.

While power saving, the Rx UE's inactive time imposes restrictions in Tx UE's resource selection for SL communications. In RAN1 #106bis-e meeting, it is established as a working assumption that physical (PHY) layer restriction will be applied when PHY layer is indicated with an active time of Rx UE. Regarding the resource selection restriction, three options were proposed:

Option 1: PHY layer selects and reports candidate resources only within the indicated active time of the Rx UE.

Option 2: PHY layer selects and reports candidate resources in which at least a subset of the candidate resources is within the indicated active time of the Rx UE.

Option 3: PHY layer selects and reports an additional candidate resource set of candidate resources within the indicated active time of the Rx UE.

In RAN1 #107-e meeting, an agreement is reached for Option 2 to implement the resource selection restriction mentioned in the RAN1 #106bis-e meeting. That is, when SL DRX active time of Rx UE is provided by the higher layer to Tx UE for candidate resource selection (including resource (re) selection and re-evaluation/pre-emption checking), the PHY layer selects and reports candidate resources, in which at least a subset of the candidate resources is within the DRX active time of the Rx UE.

However, there is currently no detailed solution and procedure on how a Tx UE properly performs resource reporting in consideration of Rx UE's DRX active time. In addition, there are some potential issues for resource selection and reporting in view of Rx UE's DRX active time:

(1) The Tx UE has Rx UE(s)' DRX active time information, but the Rx UE(s)' DRX active time is below a threshold (e.g., 20% out of S_{A}) to be reported to higher layer.

(2) The Tx UE has Rx UE(s)' DRX active time information, but the candidate resources are busy or noisy within Rx UE(s)' DRX active time.

(3) The Tx UE does not have Rx UE(s)' DRX active time information, or the Rx UE(s)' DRX active time information is outdated.

Thus, there is a need for communication methods and apparatuses to alleviate the aforementioned issues by using advance indication of resource selection as described in the present disclosure. Furthermore, other desirable features and characteristics will become apparent from the subsequent detailed description and the appended claims, taken in conjunction with the accompanying drawings and this background.

### SUMMARY

One non-limiting and exemplary embodiment facilitates providing multiple structures and methods to use advance indication of resource selection in DRX configured SL communications. In the present disclosure, the terms “advance indication” and “advanced indication” are used interchangeably, which refer to an advance notice that a Tx UE transmits to a Rx UE with information about an upcoming SL communication.

In an embodiment, the techniques disclosed herein feature a method for wireless communication at a first user equipment (UE). The method comprises: transmitting an advanced indication to a second UE for an upcoming sidelink communication with the second UE over a sidelink communication link, wherein the upcoming sidelink communication is associated with one or more selected resources that include at least one resource falling outside the second UE's active time in Discontinuous Reception (DRX) configuration.

It should be noted that general or specific embodiments may be implemented as a system, a device, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE FIGURES

In the following, exemplary embodiments are described in more detail with reference to the attached figures and drawings.

FIG. 1 shows an exemplary architecture 100 for a 3GPP NR system.

FIG. 2 is a schematic illustration 200 which shows functional split between NG-RAN and 5GC.

FIG. 3 is a sequence diagram 300 for RRC connection setup/reconfiguration procedures.

FIG. 4 is a schematic illustration 400 showing usage scenarios of Enhanced mobile broadband (eMBB), Massive Machine Type Communications (mMTC) and Ultra Reliable Low Latency Communications (URLLC).

FIG. 5 is a block diagram showing an exemplary 5G system architecture 500 for a non-roaming scenario.

FIG. 6 illustrates an exemplary DRX configured SL communication 600 between a Tx UE and a Rx UE without using an advance indication of resource selection.

FIG. 7 depicts a block diagram 700 of an exemplary communication apparatus 710 that can be implemented as a Tx UE or a Rx UE in accordance with embodiments of the present disclosure based on practical requirements.

FIG. 8 illustrates a flowchart illustrating a method 800 for wireless communication at a first UE in accordance with an embodiment of the present disclosure.

FIG. 9 illustrates a flowchart illustrating a method 900 for wireless communication at a second UE in accordance with an embodiment of the present disclosure.

FIG. 10 illustrates a flowchart illustrating an exemplary embodiment 1000 in accordance with the method 800 at the first UE depicted in FIG. 8. In FIG. 10, step 1004 shows an embodiment of step 802 in FIG. 8.

FIG. 11 illustrates a flowchart illustrating an exemplary embodiment 1100 in accordance with the method 900 at the second UE depicted in FIG. 9. In FIG. 11, step 1104 shows an embodiment of step 904 in FIG. 9.

FIG. 12 illustrates an exemplary DRX configured SL communication 1200 between a Tx UE and a Rx UE with an advance indication of resource selection in accordance with a first embodiment of the present disclosure. This embodiment depicts a SL communication link between the Tx UE and the Rx UE. In this embodiment, the advanced indication 1206 indicates a time window 1208 in advance to the at least one resource falling outside the Rx UE's active time.

FIG. 13 illustrates an exemplary DRX configured SL communication 1300 between a Tx UE and a Rx UE with an advance indication of resource selection in accordance with a second embodiment of the present disclosure. This embodiment depicts a SL communication link between the Tx UE and the Rx UE. In this embodiment, the advanced indication 1306 indicates a particular resource 1308 among the one or more selected resources to start data transmission in an upcoming sidelink communication.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the exemplary embodiments or the application and uses of the exemplary embodiments. Furthermore, there is no intention to be bound by any theory presented in the preceding background or the following detailed description.

### 5G NR System Architecture and Protocol Stacks

3GPP has been working at the next release for the 5^{th} generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones.

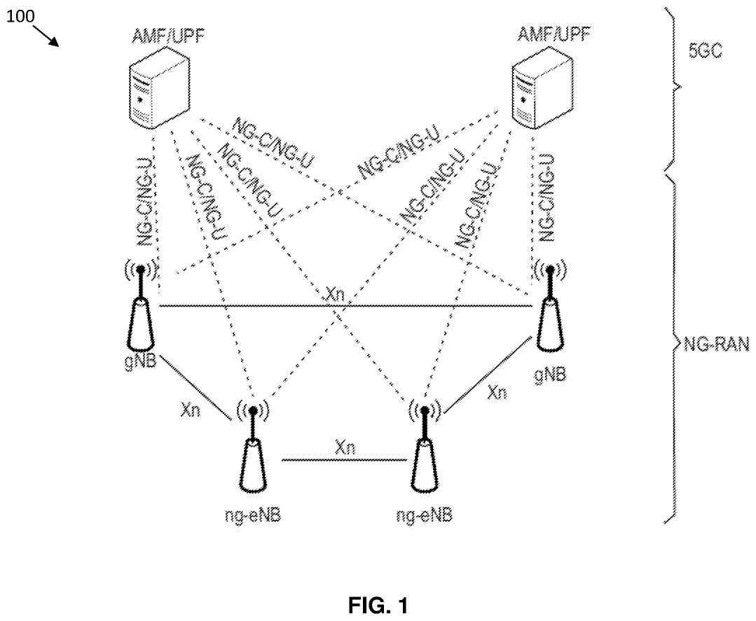

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v15.6.0, section 4).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink and PDSCH (Physical Downlink Shared Channel), PDCCH (Physical Downlink Control Channel) and PBCH (Physical Broadcast Channel) for downlink.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low-cost devices (15 years).

Therefore, the OFDM numerology (e.g., subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v15.6.0).

### 5G NR Functional Split Between NG-RAN and 5GC

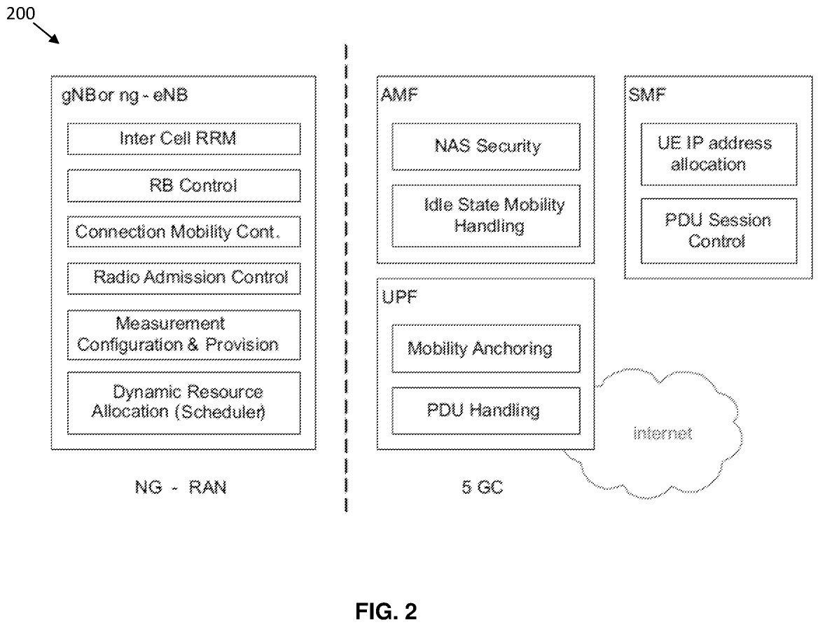

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

### RRC Connection Setup and Reconfiguration Procedures

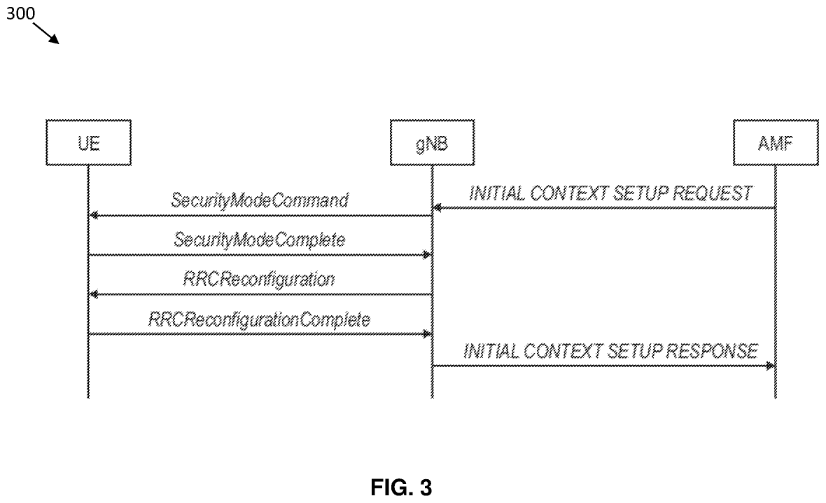

FIG. 3 illustrates some interactions between a UE, gNB, and AMF (an 5GC entity) in the context of a transition of the UE from RRC_IDLE to RRC_CONNECTED for the NAS part (see TS 38.300 v15.6.0).

RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signalling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

In the present disclosure, thus, an entity (for example AMF, SMF, etc.) of a 5th Generation Core (5GC) is provided that comprises control circuitry which, in operation, establishes a Next Generation (NG) connection with a gNodeB, and a transmitter which, in operation, transmits an initial context setup message, via the NG connection, to the gNodeB to cause a signaling radio bearer setup between the gNodeB and a user equipment (UE). In particular, the gNodeB transmits a Radio Resource Control, RRC, signaling containing a resource allocation configuration information element to the UE via the signaling radio bearer. The UE then performs an uplink transmission or a downlink reception based on the resource allocation configuration.

### Usage Scenarios of IMT for 2020 and Beyond

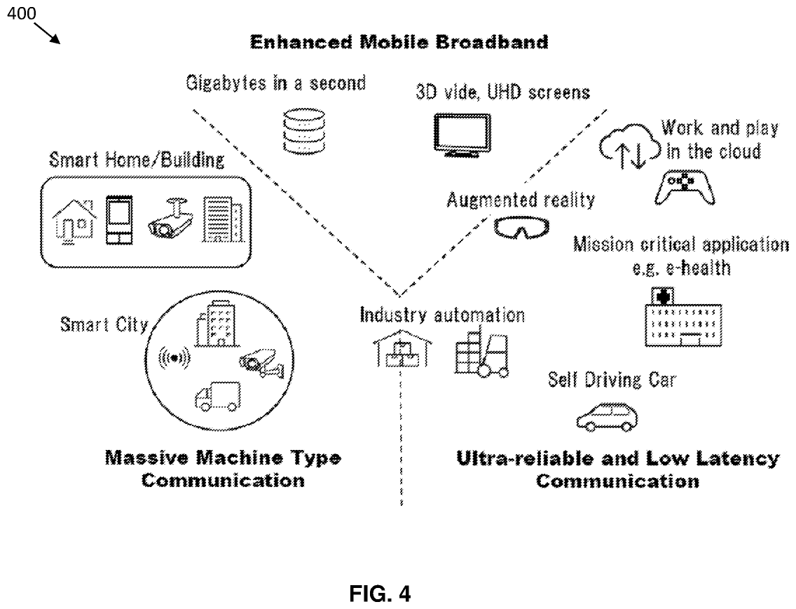

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E−5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E−5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few us where the value can be one or a few us depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

### QoS Control

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

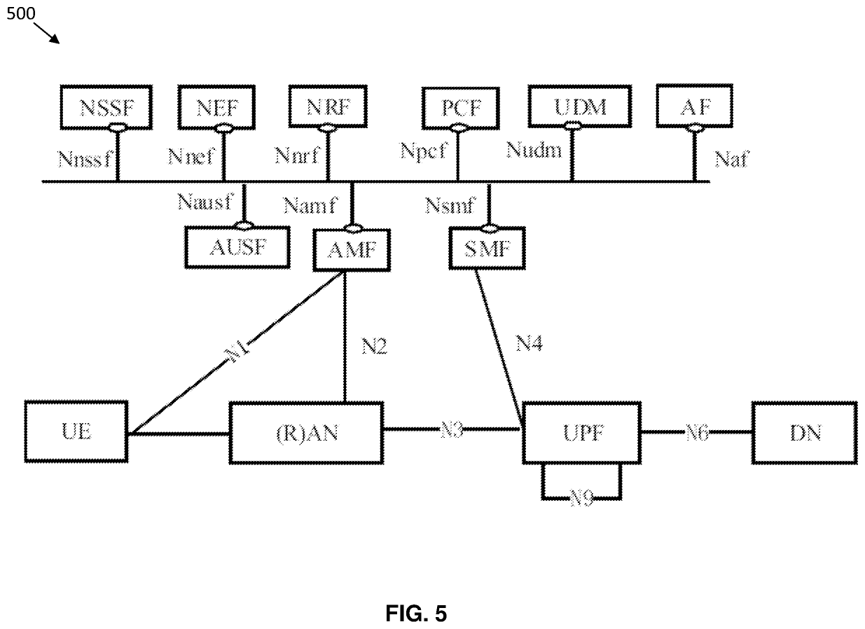

FIG. 5 illustrates a 5G NR non-roaming reference architecture (see TS 23.501 v16.1.0, section 4.23). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), e.g. operator services, Internet access or 3rd party services. All of or a part of the core network functions and the application services may be deployed and running on cloud computing environments.

In the present disclosure, thus, an application server (for example, AF of the 5G architecture), is provided that comprises a transmitter, which, in operation, transmits a request containing a QoS requirement for at least one of URLLC, eMMB and mMTC services to at least one of functions (for example NEF, AMF, SMF, PCF, UPF, etc) of the 5GC to establish a PDU session including a radio bearer between a gNodeB and a UE in accordance with the QoS requirement and control circuitry, which, in operation, performs the services using the established PDU session.

### Embodiments

It is the intent of the present disclosure to present exemplary embodiments of communication methods and apparatuses that utilize advance indication of resource selection in DRX configured SL communications. Instead of restricting Tx UE to only select (or to prioritize) resources within Rx UE's active time, the present disclosure enables Tx UE to transmit an advance indication to Rx UE(s), so that the Rx UE(s) can extend its DRX active time for an upcoming SL communication by enabling an extension timer, triggering an earlier wake-up, changing the DRX active/inactive pattern, and/or etc. In this manner, the present disclosure advantageously provides solutions and procedures for Tx UEs to properly perform resource reporting in consideration of Rx UE's DRX active time, enhances resource usage efficiency in SL communications, and has addressed the resource selection limitation and potential issues mentioned above for resource selection and reporting in view of Rx UE's DRX active time.

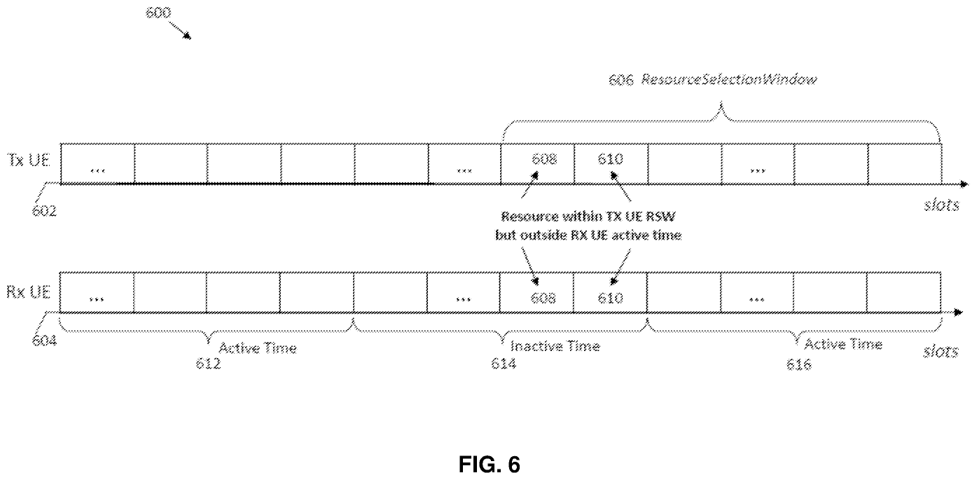

To facilitate understanding, FIG. 6 illustrates an exemplary DRX configured SL communication 600 between a Tx UE and a Rx UE without using an advance indication of resource selection. In FIG. 6, a block diagram 602 shows resources used at the Tx UE and a block diagram 604 shows resources used at the Rx UE in the SL communication 600. The resources comprise time-frequency resources. For simplicity purpose, the resources are depicted as time resource units, e.g. slots in FIG. 6. It is understood that the time resource units can be in other forms as described in the present disclosure.

In the DRX configured SL communication 600, the Tx UE selects one or more resources in a ResourceSelectionWindow 606 for an upcoming sidelink communication. However, the selected one or more resources include two resources 608, 610 that fall outside the Rx UE's active time 616, 612. Without advance indication, data transmitted from Tx UE in the two resources 608, 610 will not be received by the Rx UE. This will cause data loss and other potential issues as described above in the DRX configured SL communication 600.

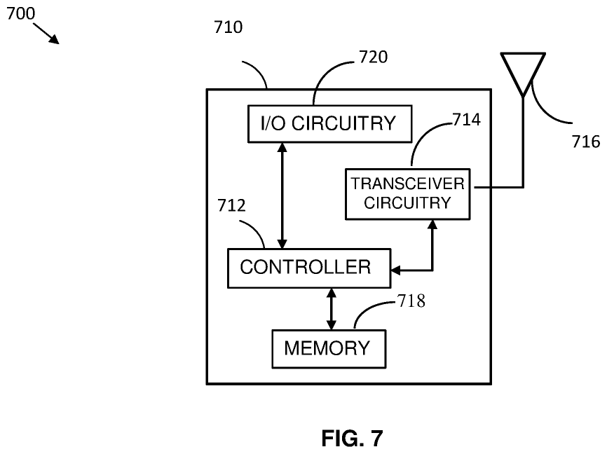

The above data loss is pre-empted and the DRX configured SL communication 600 is improved by the embodiments of the present disclosure depicted in FIGS. 7 to 13 that utilize advance indication of resource selection in DRX configured SL communications.

FIG. 7 depicts a block diagram 700 of an exemplary communication apparatus 710 that can be implemented as a Tx UE or a Rx UE in accordance with embodiments of the present disclosure based on practical requirements.

The communication apparatus 710 may include a device such as a controller 712 which is coupled to a wireless communication device, such as a transceiver 714, connected to an antenna 716 for performing a function of communication as described in the present disclosure. For example, the communication apparatus 710 may comprise the controller 712 that generates control signals and/or data signals which are used by the transceiver 714 to perform a communication function of the communication apparatus 710. The communication apparatus 710 may also comprise a memory 718 coupled to the controller 712 for storage of instructions and/or data for generation of the control signals and/or data signals by the controller 712. The communication apparatus 710 may also include input/output (I/O) circuitry 720 coupled to the controller 712 for receiving input of data and/or instructions for storage in the memory 718 and/or for generation of the control signals and/or data signals and for providing output of data in the form of audio, video, textual or other media.

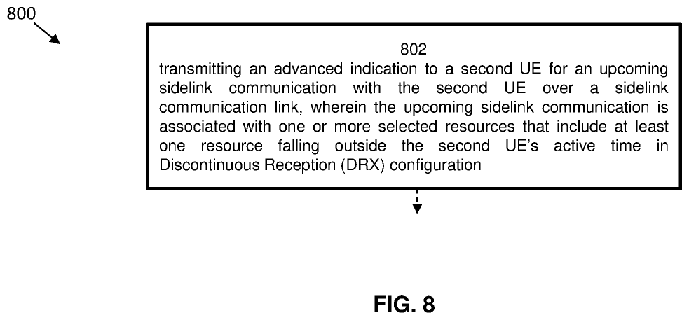

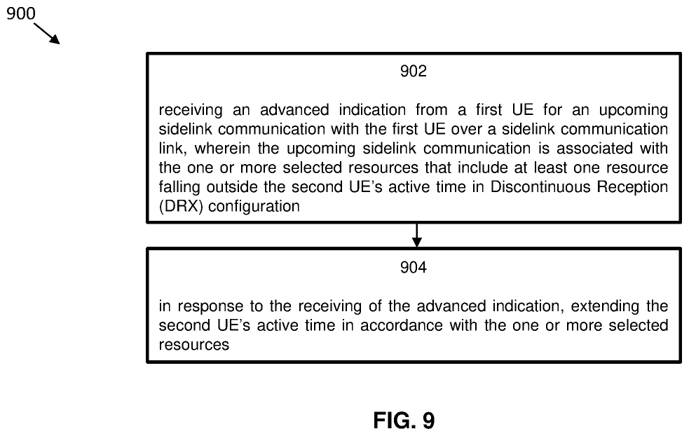

In the communication apparatus 710, the transceiver works in conjunction with the circuitry 720, which in operation performs steps in accordance with embodiments of the methods as shown in FIGS. 8 and 9.

FIG. 8 illustrates a flowchart illustrating a method 800 for wireless communication at a first UE in accordance with an embodiment of the present disclosure.

In this embodiment, the method 800 comprises a step 802 performed by the first UE:
transmitting an advanced indication to a second UE for an upcoming sidelink communication with the second UE over a sidelink communication link, wherein the upcoming sidelink communication is associated with one or more selected resources that include at least one resource falling outside the second UE's active time in Discontinuous Reception (DRX) configuration.

In the method 800, the first UE is a Tx UE. The second UE is a Rx UE. As described above, the terms “advance indication” and “advanced indication” are used interchangeably in the present disclosure, which refer to an advance notice that the Tx UE transmits to the Rx UE with information about the upcoming SL communication.

In some embodiments, the transmission of the advanced indication is in response to the Tx UE receiving a higher layer signaling. The higher layer signaling can be through MAC layer, RRC layer, etc. In other words, the advanced indication is triggered by higher layer enabling/configuration.

In some embodiments, the step 802 of transmitting the advanced indication comprises: transmitting sidelink control information (SCI) to the Rx UE via a Physical Sidelink Control Channel (PSCCH) and/or a Physical Sidelink Shared Channel (PSSCH). That is, in some examples, the advanced indication is carried by either 1st or 2nd stage SCI, either within Rx UE's active time transmitted by a PSCCH or PSCCH+PSSCH.

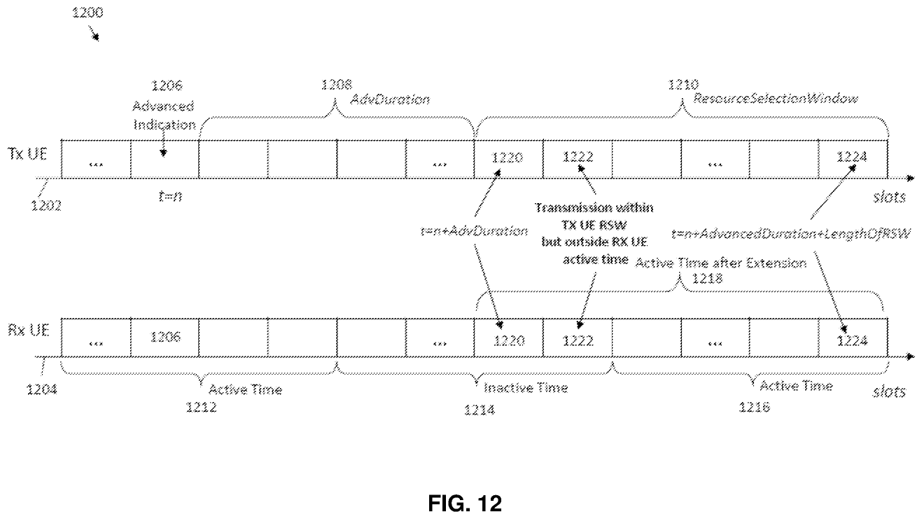

The SCI can be a 1-bit SCI information, a 2-bit SCI information, or a n-bit (n>2) SCI information. In some embodiments, the SCI is a 1-bit SCI information. The 1-bit SCI information indicates whether there is a time window in advance to the at least one resource falling outside the Rx UE's active time. An example of the time window in advance to the at least one resource falling outside the Rx UE's active time is depicted as an advanced duration (AdvDuration) 1208 in FIG. 12. For example, for the 1-bit SCI information, “1” indicates an advanced duration is used, and “0” indicates an advanced duration is not used and no extension of Rx UE's DRX active time is required for the upcoming SL communication. Or vice versa.

In some embodiments, the SCI information is a 2-bit SCI information or a n-bit SCI information. The 2-bit SCI information or n-bit SCI information indicates count, periodicity, duration, carrier, and/or bandwidth part (BWP) of one or more time windows in advance to the at least one resource falling outside the Rx UE's active time. A time window in advance to the at least one resource falling outside the Rx UE's active time is depicted as an advanced duration (AdvDuration) 1208 in FIG. 12. For example, for the 2-bit SCI information, “00” indicates an advanced duration is not used and no extension of Rx UE's DRX active time is required for the upcoming SL communication, “01” indicates an advanced duration is used for a single time, “10” indicates an advanced duration is used periodically for X (e.g., 2) times, and “11” indicates an advanced duration is used periodically for Y (e.g., 5) times. In this manner, the advanced indication advantageously provides advance notice to the Rx UE that in the upcoming X or Y times of SL communications, each SL communication will require an extension of Rx UE's DRX active time based on the advanced duration.

In another example, for the 2-bit SCI information, “10” indicates an advanced duration is used periodically at periodicity P, “11” indicates an advanced duration is used periodically at periodicity Q.

In yet another example, for the 2-bit SCI information, “01” indicates an advanced duration A is used for a single time, “10” indicates an advanced duration B is used for a single time, “11” indicates an advanced duration C is used for a single time.

In the above examples, the counts X/Y, periodicity P/Q, and duration A/B/C can be (pre-) configured/specified based on practical requirements and known to the Tx UE and the Rx UE.

It is appreciated that the 1-bit and 2-bit SCI information are not limited to the above examples and can vary based on the practical requirements.

Likewise, when n-bit (n>2) SCI information is used, the SCI information may indicate various combinations of count, periodicity, duration, carrier, and/or bandwidth part (BWP) of one or more time windows (i.e. advanced duration shown in FIG. 12) in advance to the at least one resource falling outside the Rx UE's active time.

An embodiment of the above described advanced indication of one or more time window in advance to the at least one resource falling outside the Rx UE's active time is depicted in FIG. 12. In FIG. 12, a SL communication link 1200 is depicted between the Tx UE and the Rx UE. In this embodiment, a block diagram 1202 shows resources used at the Tx UE and a block diagram 1204 shows resources used at the Rx UE. The resources comprise time-frequency resources. For simplicity purpose, the resources are depicted as time resource units, e.g. slots in FIG. 12. It is understood that the time resource units can be in other forms as described in the present disclosure.

As shown in FIG. 12, Rx UE has DRX active times 1212, 1206 and DRX inactive time 1214. It is understood that FIG. 12 shows a portion of the resources used by the Rx UE and the DRX active times 1212, 1206 and DRX inactive time 1214 as exemplified are part of Rx UE's DRX active/inactive times. In the present disclosure, the terms of Rx UE's “DRX active time” and “active time” are interchangeably used. Similarly, the terms of Rx UE's “DRX inactive time”, “inactive time” and “non-active time” are interchangeably used.

In FIG. 12, the Tx UE selects one or more resources in a ResourceSelectionWindow 1210 for an upcoming sidelink communication. The one or more selected resources includes two resources 1220, 1222 that fall outside the Rx UE's active time 1216, 1212.

As an embodiment of the step 802 as depicted in FIG. 8, the Tx UE in FIG. 12 transmits an advanced indication 1206 to the Rx UE at a time of t=n for the upcoming sidelink communication with the Rx UE over the sidelink communication link 1200. The upcoming sidelink communication is associated with the one or more selected resources that include at least one resource 1220, 1222 falling outside the Rx UE's active time 1216, 1212 in Discontinuous Reception (DRX) configuration.

This advanced indication 1206 can be a 1-bit, 2-bit or n-bit SCI information that indicates whether there is one or more time windows in advance to the at least one resource 1220, 1222 falling outside the Rx UE's active time 1216, 1212. As described above, an example of the time window is depicted as an advanced duration (AdvDuration) 1208 in FIG. 12. In some embodiments, the time window has a duration of 16 time resource slots in advance to the at least one resource 1220, 1222 falling outside the Rx UE's active time 1216, 1212. That is, in advance to a first time resource slot 1220 of Tx UE's ResourceSelection Window 1210. The duration of the time window is not limited to 16 time resource slots, it can include other number of time resource slots in advance to the at least one resource falling outside the Rx UE's active time based on the practical requirements.

In some embodiments, the Tx UE's ResourceSelectionWindow 1210 has a pre-determined length, which is depicted as LengthOfRSW. Based on the transmission time t=n of the advanced indication, the duration of the time window (AdvDuration 1208), and the length of the Tx UE's ResourceSelection Window 1210 (LengthOfRSW), the present disclosure enables the Rx UE to act in response to receiving the advanced indication to extend its DRX active time 1216 (to e.g. an extended DRX active time 1218 that spans from resource time slot 1220 to resource time slot 1224) to accommodate the upcoming SL communication associated with the one or more selected resources. An embodiment of a corresponding method at the Rx UE is depicted in FIG. 9 and described in the corresponding paragraphs.

In some embodiments, other than the transmission time t=n of the advanced indication, other time resource slots (e.g., 1st or last slot of Rx UE's DRX active/inactive time, etc.) can be used as a reference timing for the one or more time windows in advance to the at least one resource 1220, 1222 falling outside the Rx UE's active time 1216, 1212.

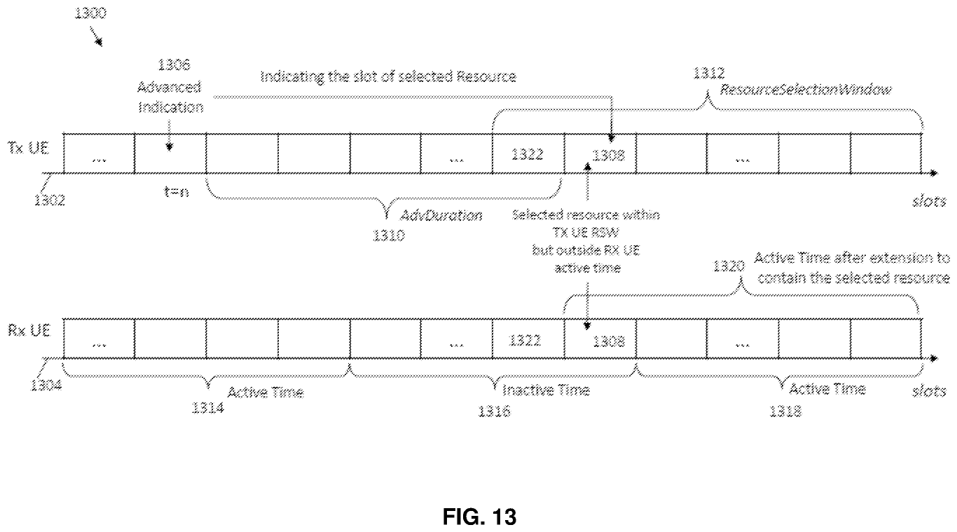

In addition or alternative to the one or more time windows as described above, the advanced indication is indicative of a particular resource among the one or more selected resources to start data transmission in the upcoming sidelink communication. An embodiment of this advanced indication is depicted in FIG. 13.

Similar to FIG. 12, a SL communication link 1300 is depicted between the Tx UE and the Rx UE in FIG. 13. In this embodiment, a block diagram 1302 shows resources used at the Tx UE and a block diagram 1304 shows resources used at the Rx UE. The resources comprise time-frequency resources. For simplicity purpose, the resources are depicted as time resource units, e.g. slots in FIG. 13. It is understood that the time resource units can be in other forms as described in the present disclosure.

As shown in FIG. 13, Rx UE has DRX active times 1318, 1314 and DRX inactive time 1316. It is understood that FIG. 13 shows a portion of the resources used by the Rx UE and the DRX active times 1318, 1314 and DRX inactive time 1316 as exemplified are part of Rx UE's DRX active/inactive times. In the present disclosure, the terms of Rx UE's “DRX active time” and “active time” are interchangeably used. Similarly, the terms of Rx UE's “DRX inactive time”, “inactive time” and “non-active time” are interchangeably used.

In FIG. 13, the Tx UE selects one or more resources in a ResourceSelectionWindow 1312 for an upcoming sidelink communication. The one or more selected resources include at least one resource 1308, 1322 that falls outside the Rx UE's active time 1318, 1314.

As another embodiment of the step 802 as depicted in FIG. 8, the Tx UE in FIG. 13 transmits an advanced indication 1306 to the Rx UE at a time of t=n for the upcoming sidelink communication with the Rx UE over the sidelink communication link 1300. The upcoming sidelink communication is associated with the one or more selected resources that include at least one resource 1308, 1322 falling outside the Rx UE's active time 1318, 1314 in Discontinuous Reception (DRX) configuration.

This advanced indication 1306 can be a 1-bit, 2-bit or n-bit SCI information that indicates a particular resource 1308 among the one or more selected resources to start data transmission in the upcoming sidelink communication. In this manner, the advanced indication 1306 in the embodiment of FIG. 13 may or may not also indicate the one or more time windows 1208 as described above with regard to FIG. 12.

In embodiments where the advanced indication 1306 also indicates the one or more time windows 1208 as described above with regard to FIG. 12, such a time window is depicted as AdvDuration 1310 in FIG. 13.

In embodiments where the advanced indication 1306 does not indicate the one or more time windows 1208 as described above with regard to FIG. 12, the advanced indication 1306 may not include information about the AdvDuration 1310.

While the embodiment shown in FIG. 13 depicts an overlapping time resource slot 1322 between the at least one resource 1308, 1322 falling outside the Rx UE's active time 1318, 1314 in Discontinuous Reception (DRX) configuration and AdvDuration 1310, it is appreciated to those skilled in the art that in other embodiments, the AdvDuration 1310 may not overlap with the at least one resource 1308, 1322 falling outside the Rx UE's active time 1318, 1314 in Discontinuous Reception (DRX) configuration.

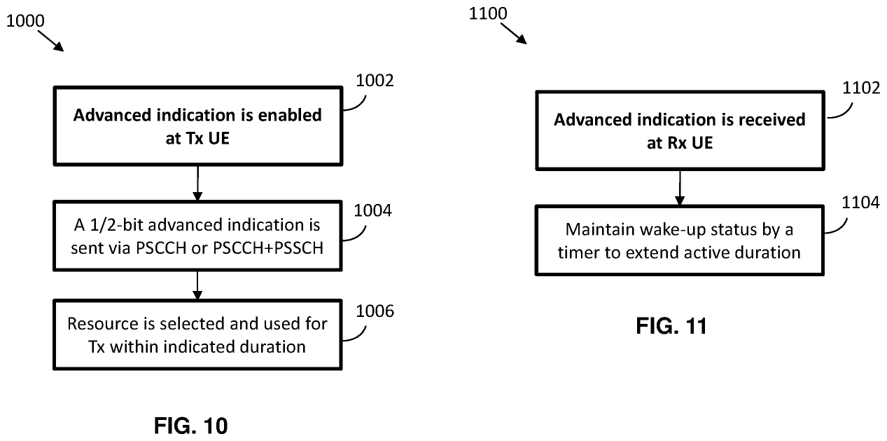

In the embodiment of FIG. 13, as the particular resource 1308 to start data transmission in the upcoming sidelink communication is indicated by the Tx UE in the advanced indication, the present disclosure enables the Rx UE to act in response to receiving the advanced indication to extend its DRX active time 1318 (to e.g. an extended DRX active time 1320 that has an earlier wake-up at the particular resource 1308) to accommodate the upcoming SL communication associated with the one or more selected resources. An embodiment of a corresponding method at the Rx UE is depicted in FIG. 10 and described in the corresponding paragraphs.

In alternative embodiments, the transmission of the advanced indication is in response to the Tx UE meeting one or more triggering conditions. The one or more triggering conditions comprise: a Channel Busy Ratio (CBR) condition, a Channel Occupation Ratio (CR) condition, a consecutive transmission failure condition, an instruction from a base station, and/or a transmission of high priority data.

For example, the CBR condition or the CR condition can include a condition where the CBR or CR is above a pre-determined threshold during measurement in a pre-determined duration of time.

For example, the consecutive transmission failure condition can include a condition where a pre-determined number of consecutive transmission failures have taken place in a pre-determined duration of time.

For example, the instruction from a base station can include an instruction that the Tx UE receives from a gNB. The gNB instruction may be in the form of PHY signaling, e.g. when the Tx UE PHY layer is indicated with an active time of Rx UE from MAC layer for candidate resource selection for the upcoming SL communication.

For example, the condition of transmission of high priority data can be a condition when the Tx UE is about to transmit high priority data (e.g., ≤3) to the Rx UE.

The above one or more triggering conditions can be individually or jointly considered and include a list of triggering levels. In addition, the CBR condition may be further classified into CBR level 1, CBR level 2, etc.

In response to different triggering levels, the Tx UE may transmit respective specific advanced indications, such as with different durations, start/end slots, counts, periodicities, etc. In other words, the one or more triggering conditions are associated with corresponding count, periodicity, duration, carrier, and/or bandwidth part (BWP) of one or more time windows in advance to a first resource of the one or more selected resources.

The list of triggering levels can also be a progressive list with Boolean algorithms. For example, the CBR condition may correspond to advanced indication operation no. 1. The consecutive transmission failure condition may correspond to advanced indication operation no. 2. A combination of CBR condition and consecutive transmission failure condition may correspond to advanced indication operation no. 3. The condition of transmission of high priority data may correspond to advanced indication operation no. 3. It is appreciated that the advanced indication operations nos. 1-3 are associated with corresponding count, periodicity, duration, carrier, and/or bandwidth part (BWP) of one or more time windows in advance to a first resource of the one or more selected resources.

In some alternative embodiments, the step 802 of transmitting the advanced indication may comprise: transmitting sidelink control information (SCI) to the Rx UE together with MAC CE. For example, SCI can be used as a 1-bit activation when a duration or time resource slots that need to wake up in Rx UE's inactive time are carried by MAC CE.

In some alternative embodiments, the step 802 of transmitting the advanced indication may comprise: transmitting one or more new or reused SCI bits (e.g., reservation field) to indicate a wake-up duration (e.g., AdditionalActiveDuration) to the Rx UE.

In some alternative embodiments, the step 802 of transmitting the advanced indication may comprise: transmitting a 1-bit advanced indication by indicating in PSFCH a particular sequence in a particular time and frequency resource.

In the above alternative embodiments, the one or more new or reused SCI bits and/or the particular sequence in PSFCH can be utilized to indicate periodic wake-up durations or particular resource slot(s). The count(s) of indication(s) can be (pre-)configured or specified.

In the above alternative embodiments, the MAC CE or RRC signaling can be utilized to change Rx UE's DRX pattern for periodic (more static) transmissions. Such periodic transmissions can be provided with a counter.

In some alternative embodiments, when in coverage (mode 1), the step 802 of transmitting the advanced indication may comprise the gNB sending advanced indication to Tx UE and/or Rx UE to extend/shorten Rx UE's DRX active times (if gNB schedules Tx UE for SL transmissions).

In some alternative embodiments, when in coverage (mode 1), new or reused PUCCH/PUSCH information bits can be utilized to request the gNB to indicate the Rx UE(s) downlink signaling for a 1-bit enabling, a wake-up duration, a particular resource slot, to change Rx UE's DRX patterns, etc.

In the above embodiments, the step 802 of transmitting the advanced indication can be performed by the Tx UE before or after the resource selection for the upcoming SL communication.

FIG. 9 illustrates a flowchart illustrating a corresponding method 900 for wireless communication at the Rx UE in response to receiving the advanced indication as transmitted by the Tx UE at step 802, in accordance with an embodiment of the present disclosure.

In this embodiment, the method 900 comprises steps 902 and 904 performed by the Rx UE:

Step 902: receiving an advanced indication from a first UE for an upcoming sidelink communication with the first UE over a sidelink communication link, wherein the upcoming sidelink communication is associated with the one or more selected resources that include at least one resource falling outside the second UE's active time in Discontinuous Reception (DRX) configuration.

Step 904: in response to the receiving of the advanced indication, extending the second UE's active time in accordance with the one or more selected resources.

In steps 902 and 904, the first UE is the Tx UE. The second UE is the Rx UE.

Corresponding to the step 802 performed by the Tx UE, the step 902 of receiving of the advanced indication at the Rx UE comprises: receiving sidelink control information (SCI) from the Tx UE via a Physical Sidelink Control Channel (PSCCH) and/or a Physical Sidelink Shared Channel (PSSCH). The SCI comprises a 1-bit SCI information, a 2-bit SCI information, or a n-bit SCI information, as described with respect to FIG. 8.

Corresponding to the step 802 performed by the Tx UE, when the SCI received in step 902 by the Rx UE is a 1-bit SCI information, the 1-bit SCI information indicates whether there is a time window in advance to the at least one resource falling outside the Rx UE's active time.

Corresponding to the step 802 performed by the Tx UE, when the SCI received in step 902 by the Rx UE is a 2-bit or n-bit SCI information, the 2-bit or n-bit SCI information indicates count, periodicity, duration, carrier, and/or bandwidth part (BWP) of one or more time windows in advance to the at least one resource falling outside the Rx UE's active time. An example of the time window is depicted in the embodiment of FIG. 12 and described above.

In addition or alternative to the one or more time windows as described above, the advanced indication received in step 902 by the Rx UE is indicative of a particular resource among the one or more selected resources to start data transmission in the upcoming sidelink communication. The particular resource is depicted in the embodiment of FIG. 13 and described above.

In response to the receiving of the advanced indication at step 902, the step 904 of extending the Rx UE's active time in accordance with the one or more selected resources comprises one or more of the following sub-steps.

Sub-step 904A: triggering a DRX active timer for a predetermined expirable time period.

Sub-step 904B: triggering a DRX active timer until expiration of the one or more selected resources.

Sub-step 904C: triggering a DRX active timer until expiration of the particular resource.

Sub-step 904D: configuring an earlier wake-up for the one or more selected resources or the particular resource.

Sub-step 904E: changing a DRX active timer to an always-on mode and resetting the Rx UE to its default DRX until expiration of the one or more selected resources or the particular resource.

Sub-step 904F: triggering periodic DRX active timers for periodic transmissions from the Tx UE.

Sub-step 904G: configuring periodic earlier wake-ups for periodic transmissions from the Tx UE.

Referring to the embodiment of FIG. 12, the step 904 of extending the Rx UE's active time can also be realised by a sub-step 904H which extends the Rx UE's active time 1216 to the extended active time 1218 for a period by enabling a timer at least from t=n+AdvDuration to t=n+AdvDuration+LengthOfRSW. That is, the extended active time 1218 spans from time resource slot 1220 to time resource slot 1224. It is appreciated to those skilled in the art that the period may or may not start from the time resource slot it receives the advanced indication 1206.

FIG. 10 illustrates a flowchart illustrating an exemplary embodiment 1000 in accordance with the method 800 at the Tx UE depicted in FIG. 8. In FIG. 10, step 1004 shows an embodiment of step 802 in FIG. 8.

The embodiment 1000 includes steps 1002, 1004 and 1006. At step 1002, the advanced indication is enabled at the Tx UE. Such an enabling can be realized by the above described higher layer signaling or the one or more triggering conditions as described with regards to FIG. 8.

At step 1004, the Tx UE transmits a 1-bit or 2-bit advanced indication to the Rx UE via PSCCH or PSCCH+PSSCH. The 1-bit or 2-bit advanced indication is as described with regards to FIG. 8.

At step 1006, the Tx UE selects one or more resources for the upcoming SL communication and uses the one or more resources within an indicated duration. As descried with regards to FIG. 8, the one or more resources include at least one resource falling outside the second UE's active time in Discontinuous Reception (DRX) configuration.

FIG. 11 illustrates a flowchart illustrating an exemplary embodiment 1100 in accordance with the corresponding method 900 at the Rx UE depicted in FIG. 9. In FIG. 11, step 1104 shows an embodiment of step 904 in FIG. 9.

The embodiment 1100 includes steps 1102 and 1104. At step 1102, the advanced indication is received at the Rx UE. The advanced indication is as described with regards to FIG. 8.

At step 1104, the Rx UE maintains a wake-up status by a timer to extend the Rx UE's active time. The extension of the Rx UE's active time is as described with regards to FIG. 9.

In the present disclosure, the Rx UE's active time comprises resources exclusively used in New Radio (NR) sidelink communications. The Rx UE's non-active time comprises resources shared with Long-Term Evolution (LTE) communications or resources used only for LTE communications.

In the present disclosure, the Rx UE's active time can alternatively comprise resources exclusively used in Long-Term Evolution (LTE) sidelink communications. The second UE's non-active time comprises resources shared with New Radio (NR) communications or resources used only for NR communications.

In the above manner, the exemplary embodiments in accordance with the present disclosure can be compatible in both NR and LTE communications.

In the present disclosure, the exemplary embodiments in accordance with the present disclosure can be applied for unicast, groupcast, or broadcast SL communications. In groupcast or broadcast SL communications, there may be one or more Rx UEs communicating with the Tx UE. The above described method 900 can be applied to the one or more Rx UEs.

Thus, it can be seen that the exemplary embodiments in accordance with the present disclosure provide communication apparatuses and communication methods for advance indication of resource selection in DRX configured SL communications as described hereinabove to overcome the potential drawbacks of Tx UE's selection/reporting limitation on candidate resources, such that the Tx UE can advantageously perform a normal resource selection without limiting candidate resources to Rx UE's active time only.

The present disclosure can be realized by software, hardware, or software in cooperation with hardware. Each functional block used in the description of each embodiment described above can be partly or entirely realized by a LSI, such as an integrated circuit, and each process described in each embodiment may be controlled partly or entirely by the same LSI or a combination of LSIs. The LSI may be individually formed as integrated circuit chips, or one chip may be formed so as to include a part or all of the functional blocks. The LSI may include a data input and output coupled thereto. The LSI may be referred to as an integrated circuit (IC), a system LSI, a super LSI, or an ultra-LSI depending on a difference in the degree of integration. However, the technique of implementing an integrated circuit is not limited to the LSI and may be realized by using a dedicated circuit, a general-purpose processor, or a special purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include a radio frequency (RF) module including amplifiers, RF modulators/demodulators and the like, and one or more antennas.

Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (e.g., digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”. The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus may also include an infrastructure facility, such as a base station, an access point, and any other apparatus, device or system that communicates with or controls apparatuses such as those in the above non-limiting examples.

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sildelink control information (SCI) or the 2nd stage SCI.

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in side link communication, a terminal may be adopted instead of a base station. The base station may be a relay apparatus that relays communication between a higher node and a terminal. The base station may be a roadside unit as well.

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

The present disclosure may be applied to any of a licensed band and an unlicensed band.

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

While exemplary embodiments have been presented in the foregoing detailed description of the present disclosures, it should be appreciated that a vast number of variations exist. It should further be appreciated that the exemplary embodiments are only examples, and are not intended to limit the scope, applicability, operation, or configuration of the present disclosure in any way. Rather, the foregoing detailed description will provide those skilled in the art with a convenient road map for implementing exemplary embodiments, it being understood that various changes may be made in the function and arrangement of the communication apparatuses, either in station mode (STA) or access point mode (AP), as described in the exemplary embodiments without departing from the scope of the present disclosure as set forth in the appended claims.

1. A method for wireless communication at a first user equipment (UE), the method comprising: transmitting an advanced indication to a second UE for an upcoming sidelink communication with the second UE over a sidelink communication link, wherein the upcoming sidelink communication is associated with one or more selected resources that include at least one resource falling outside the second UE's active time in Discontinuous Reception (DRX) configuration.

2. The method according to claim 1, wherein the transmitting of the advanced indication is in response to the first UE receiving a higher layer signalling.

3. The method according to claim 1 or 2, wherein the transmitting of the advanced indication comprises: transmitting sidelink control information (SCI) to the second UE via a Physical Sidelink Control Channel (PSCCH) and/or a Physical Sidelink Shared Channel (PSSCH), wherein the SCI comprises a 1-bit SCI information, a 2-bit SCI information, or a n-bit SCI information.

4. The method according to claim 3, wherein when the SCI is a 1-bit SCI information, the 1-bit SCI information indicates whether there is a time window in advance to the at least one resource falling outside the second UE's active time.

5. The method according to claim 3, wherein when the SCI information is a 2-bit SCI information, the 2-bit SCI information indicates count, periodicity, duration, carrier, and/or bandwidth part (BWP) of one or more time windows in advance to the at least one resource falling outside the second UE's active time.

6. The method according to any one of the preceding claims, wherein the advanced indication is indicative of a particular resource among the one or more selected resources to start data transmission in the upcoming sidelink communication.

7. The method according to any one of the preceding claims, wherein the second UE's active time comprises resources exclusively used in New Radio (NR) sidelink communications, and wherein the second UE's non-active time comprises resources shared with Long-Term Evolution (LTE) communications or resources used only for LTE communications.

8. The method according to any one of the preceding claims, wherein the second UE's active time comprises resources exclusively used in Long-Term Evolution (LTE) sidelink communications, and wherein the second UE's non-active time comprises resources shared with New Radio (NR) communications or resources used only for NR communications.

9. The method according to claim 1, wherein the transmitting of the advanced indication is in response to the first UE meeting one or more triggering conditions, the one or more triggering conditions comprising a Channel Busy Ratio (CBR) condition, a Channel Occupation Ratio (CR) condition, a consecutive transmission failure condition, an instruction from a base station, and/or a transmission of high priority data.

10. The method according to claim 9, wherein the one or more triggering conditions are associated with corresponding count, periodicity, duration, carrier, and/or bandwidth part (BWP) of one or more time windows in advance to a first resource of the one or more selected resources.

11. A method for wireless communication at a second user equipment (UE), the method comprising: receiving an advanced indication from a first UE for an upcoming sidelink communication with the first UE over a sidelink communication link, wherein the upcoming sidelink communication is associated with the one or more selected resources that include at least one resource falling outside the second UE's active time in Discontinuous Reception (DRX) configuration; and in response to the receiving of the advanced indication, extending the second UE's active time in accordance with the one or more selected resources.

12. The method according to claim 11, wherein the receiving of the advanced indication comprises: receiving sidelink control information (SCI) from the first UE via a Physical Sidelink Control Channel (PSCCH) and/or a Physical Sidelink Shared Channel (PSSCH), wherein the SCI comprises a 1-bit SCI information, a 2-bit SCI information, or a n-bit SCI information.

13. The method according to claim 12, wherein when receiving the advanced indication comprises receiving a 1-bit SCI information, the 1-bit SCI information indicates whether there is a time window in advance to the at least one resource falling outside the second UE's active time.

14. The method according to claim 12, wherein when receiving the advanced indication comprises receiving a 2-bit SCI information, the 2-bit SCI information indicates count, periodicity, duration, carrier, and/or bandwidth part (BWP) of one or more time windows in advance to the at least one resource falling outside the second UE's active time.

15. The method according to any one of claims 11-14, wherein receiving the advanced indication is indicative of a particular resource among the one or more selected resources to start data transmission in the upcoming sidelink communication.

16. The method according to claim 15, wherein the extending of the second UE's active time in accordance with the one or more selected resources comprises: triggering a DRX active timer for a predetermined expirable time period; triggering a DRX active timer until expiration of the one or more selected resources; triggering a DRX active timer until expiration of the particular resource; configuring an earlier wake-up for the one or more selected resources or the particular resource; changing a DRX active timer to an always-on mode and resetting the second UE to its default DRX until expiration of the one or more selected resources or the particular resource; triggering periodic DRX active timers for periodic transmissions from the first UE; and/or configuring periodic earlier wake-ups for periodic transmissions from the first UE.

17. The method according to any one of claims 11-16, wherein the second UE's active time comprises resources exclusively used in New Radio (NR) sidelink communications, and wherein the second UE's non-active time comprises one or more selected resources shared with Long-Term Evolution (LTE) communications or one or more selected resources used only for LTE communications.

18. The method according to any one of claims 11-16, wherein the second UE's active time comprises resources exclusively used in Long-Term Evolution (LTE) sidelink communications, and wherein the second UE's non-active time comprises resources shared with New Radio (NR) communications or resources used only for NR communications.

19. A communication apparatus with a sidelink Discontinuous Reception (DRX) configuration, the device comprising: a transceiver; and circuitry, wherein the transceiver works in conjunction with the circuitry, which in operation perform one or more steps in accordance with any one of claims 1 to 10.

20. A communication apparatus with a sidelink Discontinuous Reception (DRX) configuration, the device comprising: a transceiver; and circuitry, wherein the transceiver works in conjunction with the circuitry, which in operation perform one or more steps in accordance with any one of claims 11 to 18.

1. A method for wireless communication at a first user equipment (UE), the method comprising:
transmitting an advanced indication to a second UE for an upcoming sidelink communication with the second UE over a sidelink communication link,
wherein the upcoming sidelink communication is associated with one or more selected resources that include at least one resource falling outside the second UE's active time in Discontinuous Reception (DRX) configuration.

2. The method according to claim 1, wherein the transmitting of the advanced indication is in response to the first UE receiving a higher layer signaling.

3. The method according to claim 1, wherein the transmitting of the advanced indication comprises:
transmitting sidelink control information (SCI) to the second UE via a Physical Sidelink Control Channel (PSCCH) and/or a Physical Sidelink Shared Channel (PSSCH),
wherein the SCI comprises a 1-bit SCI information, a 2-bit SCI information, or a n-bit SCI information.

4. The method according to claim 3, wherein when the SCI is a 1-bit SCI information, the 1-bit SCI information indicates whether there is a time window in advance to the at least one resource falling outside the second UE's active time.

5. The method according to claim 3, wherein when the SCI information is a 2-bit SCI information, the 2-bit SCI information indicates count, periodicity, duration, carrier, and/or bandwidth part (BWP) of one or more time windows in advance to the at least one resource falling outside the second UE's active time.

6. The method according to claim 1, wherein the advanced indication is indicative of a particular resource among the one or more selected resources to start data transmission in the upcoming sidelink communication.

7. The method according to claim 1, wherein the second UE's active time comprises resources exclusively used in New Radio (NR) sidelink communications, and wherein the second UE's non-active time comprises resources shared with Long-Term Evolution (LTE) communications or resources used only for LTE communications.

8. The method according to claim 1, wherein the transmitting of the advanced indication is in response to the first UE meeting one or more triggering conditions, the one or more triggering conditions comprising a Channel Busy Ratio (CBR) condition, a Channel Occupation Ratio (CR) condition, a consecutive transmission failure condition, an instruction from a base station, and/or a transmission of high priority data.

9. The method according to claim 8, wherein the one or more triggering conditions are associated with corresponding count, periodicity, duration, carrier, and/or bandwidth part (BWP) of one or more time windows in advance to a first resource of the one or more selected resources.

10. A method for wireless communication at a second user equipment (UE), the method comprising:
receiving an advanced indication from a first UE for an upcoming sidelink communication with the first UE over a sidelink communication link, wherein the upcoming sidelink communication is associated with the one or more selected resources that include at least one resource falling outside the second UE's active time in Discontinuous Reception (DRX) configuration; and
in response to the receiving of the advanced indication, extending the second UE's active time in accordance with the one or more selected resources.

11. The method according to claim 10, wherein the receiving of the advanced indication comprises:
receiving sidelink control information (SCI) from the first UE via a Physical Sidelink Control Channel (PSCCH) and/or a Physical Sidelink Shared Channel (PSSCH),
wherein the SCI comprises a 1-bit SCI information, a 2-bit SCI information, or a n-bit SCI information.

12. The method according to claim 11, wherein when receiving the advanced indication comprises receiving a 1-bit SCI information, the 1-bit SCI information indicates whether there is a time window in advance to the at least one resource falling outside the second UE's active time.

13. The method according to claim 11, wherein when receiving the advanced indication comprises receiving a 2-bit SCI information, the 2-bit SCI information indicates count, periodicity, duration, carrier, and/or bandwidth part (BWP) of one or more time windows in advance to the at least one resource falling outside the second UE's active time.

14. The method according to claim 11, wherein receiving the advanced indication is indicative of a particular resource among the one or more selected resources to start data transmission in the upcoming sidelink communication.

15. The method according to claim 14, wherein the extending of the second UE's active time in accordance with the one or more selected resources comprises:
triggering a DRX active timer for a predetermined expirable time period;
triggering a DRX active timer until expiration of the one or more selected resources;
triggering a DRX active timer until expiration of the particular resource;
configuring an earlier wake-up for the one or more selected resources or the particular resource;
changing a DRX active timer to an always-on mode and resetting the second UE to its default DRX until expiration of the one or more selected resources or the particular resource;
triggering periodic DRX active timers for periodic transmissions from the first UE; and/or
configuring periodic earlier wake-ups for periodic transmissions from the first UE.

16. The method according to claim 10, wherein the second UE's active time comprises resources exclusively used in New Radio (NR) sidelink communications, and wherein the second UE's non-active time comprises one or more selected resources shared with Long-Term Evolution (LTE) communications or one or more selected resources used only for LTE communications.

17. A communication apparatus with a sidelink Discontinuous Reception (DRX) configuration, wherein the communication apparatus is a first user equipment (UE), the communication apparatus comprising:
a transceiver, which in operation, transmits an advanced indication to a second UE for an upcoming sidelink communication with the second UE over a sidelink communication link,
wherein the upcoming sidelink communication is associated with one or more selected resources that include at least one resource falling outside the second UE's active time in Discontinuous Reception (DRX) configuration; and
circuitry, which in operation, controls the transceiver.

18.-20. (canceled)
